(19) United States
(12) Patent Application Publication
(10) Pub. No.: US 2026/0225352 A1
(43) Pub. Date: Aug. 6, 2026

(54) DIRECT DEPOSITION OF NANOPARTICLES ON A SOLID SUBSTRATE IN A CAPTURE FLUID

(71) Applicants: Dow Silicones Corporation, Midland, MI (US); Rohm and Haas Company, Collegeville, PA (US)

(72) Inventors: James A. Casey, Midland, MI (US); Eric C. Greyson, Blue Bell, PA (US); David Witker, Midland, MI (US); Xindi Yu, Paoli, PA (US)

(21) Appl. No.: 19/151,372

(22) PCT Filed: Feb. 1, 2024
(86) PCT No.: PCT/US2024/013991

§ 371 Date: Jul. 28, 2025

Related U.S. Application Data
(60) Provisional application No. 63/444,594, filed on Feb. 10, 2023.

(51) Int. Cl. B32B 17/10

(52) U.S. Cl. CPC B32B 17/10302; B32B 17/10669; B32B 2307/422; B32B 2313/00; B32B 2315/08

(57) ABSTRACT

A method for directly coating a silicon nanoparticle onto a solid substrate uses a VHFLPP process that collects silicon nanoparticles in a capture fluid as they are made and is further characterized by having a solid substrate submerged in the capture fluid during collection of silicon nanoparticles.

### FIELD OF THE INVENTION

The present invention relates to a method for depositing nanoparticles onto a solid substrate that is in a capture fluid during the manufacturing of the nanoparticles.

### INTRODUCTION

The advent of nanotechnology is resulting in a paradigm shift in many technological arts because the properties of many materials change at nanoscale dimensions. For example, decreasing the dimensions of some structures to nanoscales can increase the ratio of surface area to volume, thus causing changes in the electrical, magnetic, reactive, chemical, structural, and thermal properties of the material. Nanomaterials are already being found in commercial applications and will likely be present in a wide variety of technologies including computers, photovoltaics, optoelectronics, medicine/pharmaceuticals, structural materials, military applications, and many others within the next few decades.

Silicon nanoparticles are of particular interest. An important characteristic of small silicon nanoparticles (less than 10 nanometer (nm) average size) is that these particles are photoluminescent in visible and near infrared light when stimulated by shorter wavelength light (such as ultraviolet light). This is thought to be caused by a quantum confinement effect that occurs when the diameter of the nanoparticle is smaller than the exciton radius, which results in bandgap bending (that is, increasing of the gap). Researchers have shown how the bandgap energy (in electron volts) of a nanoparticle changes as a function of the diameter of the nanoparticle.

Although silicon is an indirect bandgap semiconductor in bulk, silicon nanoparticles with average sizes less than 10 nm emulate a direct bandgap material, which is made possible by interface trapping of excitons. Direct bandgap materials can be used in optoelectronics applications as silicon quantum dot materials. Silicon quantum dots are particularly desirable over other quantum dot materials because they do not require environmentally unfriendly components such as lead, selenium, cadmium, indium, or arsenic. Another interesting property of nanomaterials is the lowering of the melting point following the surface-phonon instability theory. Researchers have shown that the melting point of a nanomaterial formed of nanoparticles changes as a function of the diameter of the nanoparticle.

There are applications where it is desirable to have silicon nanoparticles coating a surface of an article. For instance, displays and photovoltaics often benefit from having quantum dot materials (such as silicon quantum dots) coating the surface of a glass substrate.

A challenge in obtaining such articles is that there typically needs to be a binder applied to a substrate and/or the nanoparticle in order to adhere the nanoparticle to the substrate and binders can inhibit performance properties of the resulting coating substrate-such as interfering with light transmission through a glass substrate coated with quantum dots.

Another challenge is to coat multiple sides of three-dimensional substrates efficiently. It is possible to directly deposit silicon nanoparticles onto a solid substrates surface from a nanoparticle beam upon manufacturing the silicon nanoparticles. However, such a process is a line-of-sight deposition that coats only a top surface that is exposed to the nanoparticle beam to silicon nanoparticles, while side of the substrate remain essentially non-coated and would require subsequent passes under a nanoparticle beam to coat the sides. It is desirable to be able to coat multiple, preferably all, surfaces of a substrate with silicon nanoparticles at one time.

Yet another challenge is to efficiently passivate the silicon nanoparticles upon coating them onto a substrate. Non-passivated silicon nanoparticles are unstable to exposure to oxygen and moisture so they must be maintained in an inert atmosphere until passivated. It would be desirable to have a process that allowed for coating a solid substrate with silicon nanoparticles from a nanoparticle beam directly upon making the silicon nanoparticles and yet allowed for easy handling of the silicon nanoparticle coated substrate without concern for maintaining under an inert atmosphere until passivated.

It would advance the art of preparing silicon nanoparticle coated solid substrates to provide a process that: (a) coats a solid substrate with silicon nanoparticles from a nanoparticle beam in which the silicon nanoparticles are made more uniformly than achieved by exposing the solid substrate to the nanoparticle beam directly and (b) coats the surface of a solid substrate without requiring a separate step of applying an adhesion promoter to the substrate, and ideally did not require an adhesion promoter at all. Additionally, it is desirably if the method (c) can coat multiple surfaces of a solid substrate simultaneously with quantum dots from the nanoparticle beam including surfaces other than one surface directly exposed to a nanoparticle beam containing silicon nanoparticles; and/or (d) allows for coating a solid substrate with silicon nanoparticles from a nanoparticle beam directly upon making the silicon nanoparticles and yet allowed for easy handling of the silicon nanoparticle coated substrate without concern for maintaining under an inert atmosphere until passivated.

### BRIEF SUMMARY OF THE INVENTION

The present invention provides a process for applying nanoparticles onto a solid substrate that: (a) coats a solid substrate with silicon nanoparticles from a nanoparticle beam in which the silicon nanoparticles are made more uniformly than achieved by exposing the solid substrate to the nanoparticle beam directly and (b) coats the surface of a solid substrate without requiring a separate step of applying an adhesion promoter to the substrate, and ideally did not require an adhesion promoter at all. Additionally, process (c) can coat multiple surfaces of a solid substrate simultaneously with quantum dots from the nanoparticle beam including surfaces other than one surface directly exposed to a nanoparticle beam containing silicon nanoparticles; and/or (d) allows for coating a solid substrate with silicon nanoparticles from a nanoparticle beam directly upon making the silicon nanoparticles and yet allowed for easy handling of the silicon nanoparticle coated substrate without concern for maintaining under an inert atmosphere until passivated.

The present invention is a result of discovering that when a solid substrate is placed in a capture fluid of a very high frequency low pressure plasma (VHFLPP) process the silicon nanoparticles disperse in the capture fluid and coat surfaces of the solid substrate even beyond the surface directly facing the nanoparticle beam impinging the capture fluid. Such a disposition of the silicon nanoparticles onto the solid substrate surface is continuous with the process of making the silicon nanoparticles thereby obviating a need for separate steps of making the silicon nanoparticles and then disposing them onto a solid substrate surface. The freshly made silicon nanoparticles tend to coat solid substrate surfaces without need for a separate binder. In fact, freshly made silicon nanoparticles have reactive sites on their surfaces that can react with functionalities on some solid substrate surfaces thereby chemically binding the nanoparticle to the solid substrate surface. For example, Si—OH functionality on the surface of glass substrates can react with freshly made silicon nanoparticles to bind the silicon nanoparticles to the glass substrate surface. Moreover, the capture fluid protects the silicon nanoparticles on the substrate from air and moisture allowing handling of the freshly coated substrate without providing for an inert atmosphere beyond the capture fluid in which the coated substrate was made. The silicon nanoparticles can then be passivated directly in the capture fluid to make the silicon nanoparticle coated substrate stable to removal from the capture fluid.

Notably, a nanoparticle beam containing silicon nanoparticles can be used to directly coat a solid substrate in a VHFLPP process without having the solid substrate submerged in a capture fluid. However, as shown in the Examples section hereinbelow, the result is a less uniform coating than is achieved by having the solid substrate submerged in a capture fluid. Additionally, the coated solid substrate must either subsequently be submerged in a capture fluid or maintained in an inert atmosphere until the silicon nanoparticles are passivated or the silicon nanoparticles will decompose.

In a first aspect, the present invention is a method for directly coating a silicon nanoparticle onto a solid substrate, the method comprising a VHFLPP process that collects silicon nanoparticles in a capture fluid as they are made wherein the process is further characterized by having a solid substrate submerged in the capture fluid during collection of silicon nanoparticles.

The method of the present invention is useful for making solid substrates that are coated with silicon nanoparticles, including silicon quantum dots, which are useful for further fabrication of articles such as optical displays, photovoltaics, and other photoactive articles.

### BRIEF DESCRIPTION OF DRAWINGS

FIG. 1 illustrates a schematic of the VHFLPP set up for use in preparing the examples herein.

### DETAILED DESCRIPTION OF THE INVENTION

Products identified by their tradename refer to the compositions available under those tradenames on the priority date of this document.

“Multiple” means two or more. “And/or” means “and, or as an alternative”. All ranges include endpoints unless otherwise indicated.

“Cx to Cy”, “Cₓ-C_{y}”, “C_{x-y}” are interchangeable and refer to a composition having a number of carbon atoms in a range of from x to y.

“Silicon nanoparticle” refers to a silicon-based particle having an average particle size of less than one micrometer, typically a particle size of 100 nanometers (nm) or less, while at the same time having an average particle size of one or more than one nm. Dynamic light scattering or transmission electron microscopy image analysis are common ways to determine average particle size for silicon nanoparticles. Silicon nanoparticles include silicon quantum dots.

“Silicon-based” refers to a composition comprising silicon. A silicon-based material generally contains 40 percent (%) or more, and can contain 50% or more, 60% or more, 70% or more, 80% or more, 90% or more, even 100% silicon atoms or a combination of silicon and oxygen atoms based relative to all atoms in the material.

“Silicon quantum dots” refer to silicon nanoparticles that have a crystalline silicon structure and that photoluminesces when exposed to light. Typically, silicon quantum dots have an average particle size that is in a range of one to 10 nanometers, preferably in a range of one to 6 nanometers, more preferably in a range of one to 5 nanometers. Silicon quantum dots are characterized by the fact that they luminesce when exposed to light having a wavelength in a wavelength range of 300 to 477 nanometers, corresponding to blue and ultraviolet light.

The present invention is a method for direct deposition of a silicon nanoparticles onto a solid substrate in a capture fluid of a very high frequency low pressure plasma (VHFLPP) process. The VHFLPP is a generally known process for making nanoparticles, and in the case of the present application silicon nanoparticles including silicon quantum dots. The VHFLPP process provides capability to provide better control over particle size and size distribution when producing nanoparticles than other processes for making nanoparticles offer. Examples of VHFLPP processes are taught in prior art, including in US2013/0189446, US2012/0326089 and WO2020/205850. A basic description of the VHFLPP process follows.

The VHFLPP process uses a gas stream comprising at least one nanoparticle precursor that flows through a quartz tube at a pressure below 13,333 Pascals (Pa). To make silicon nanoparticles, the nanoparticle precursor is or comprises a silicon-containing material typically selected from a group consisting of silanes, disilanes, halogen-substituted silanes, halogen-substituted disilanes, C1 to C4 alkyl silanes, C1 to C4 alkyl disilanes and mixtures of any combination thereof. The gas stream can contain additional precursors (dopants) that typically contain a component, or any combination of components selected from a group consisting of halogens, germanium, boron, phosphorus and nitrogen. The combined concentration of nanoparticle precursor and dopant in the gas stream typically ranges from 0.1 to 50 percent by volume (vol %) relative to the gas stream composition. The balance of the gas stream is primarily one or a combination of more than one inert gas such as argon (Ar), Helium (He), Neon (Ne), Krypton (Kr), Xenon (Xe), and Radon (Rn).

Exterior and concentric to the quartz tube are two ring electrodes, typically copper ring electrodes separated from one another with one ring electrode “upstream” (relative to the gas stream) with respect to the other ring electrode. A plasma is created within the quartz tube by powering the upstream ring electrode with a radio frequency source while grounding the other ring electrode. The radio frequency is a very high frequency (typically ranging from 30 to 500 Megahertz) and is coupled to a power typically ranging from 80 to 1000 Watts.

The nanoparticle precursor breaks down, nucleates and grows into nanoparticles as it flows through the plasma. The pressure at the plasma is 6666 Pascals (Pa) or less, and preferably 667 Pa or less while at the same time is typically 133 Pa or more.

The nanoparticles continue to flow in the gas stream and exit the quartz tube through an orifice into a collection chamber. The collection chamber is at a pressure of less than 13.33 Pascals (Pa) while the gas stream is flowing. When the gas stream is not flowing, the collection chamber is typically at a pressure of 6.67×10⁻⁵ Pa.

A capture fluid reservoir that contains a capture fluid resides in the collection chamber with the gas stream directed at the capture fluid. The distance between the surface of the capture fluid and the orifice of the quartz tube is desirably in a range of 5 to 50 orifice diameters. The gas stream containing nanoparticles impinges the surface of the capture fluid thereby introducing the nanoparticles into the capture fluid where the nanoparticles collect during the VHFLPP process. Typically, in order to assist dispersing the nanoparticles in the capture fluid, the capture fluid is agitated (for example, stirred or subjected to ultrasonic agitation) during nanoparticle collection and/or the reservoir containing the capture fluid rotates during nanoparticle collection. After capture is complete, it is also helpful to sonicate the capture fluid containing the nanoparticles to facilitate dispersing of the nanoparticles.

The capture fluid should have a vapor pressure sufficiently low so as to remain primarily intact in the reservoir within the collection chamber during the VHFLPP process. The capture fluid is desirably non-aqueous. Examples of suitable capture fluids include mineral oil, silicone oils (such as polydimethylsiloxane (PDMS), phenyl methyl-dimethyl cyclosiloxane, tetramethyltetraphenyltrisiloxane, and pentaphenyltrimethyltrisiloxane), fluorocarbons, and alkylene oxide oils. The capture fluid can be a blend of more than one fluid. Additional desirable properties and examples of suitable capture fluids are taught in WO2020/205850 in paragraphs [0070] to [0077], which teachings are incorporated herein by reference as desirably applying to the capture fluid of the present invention.

The capture fluid can provide a protective medium for storage and controlled passivation of the nanoparticles after generating the nanoparticles. Silicon nanoparticles can rapidly degrade if exposed directly to moist air. However, an oxide layer can form in a controlled manner by exposing the silicon nanoparticles in the capture fluid to moist air at a controlled temperature as moisture and oxygen slowly penetrate the capture fluid and react with the silicon nanoparticle surfaces to form an oxide. Once passivated, the silicon nanoparticles can be isolated from the capture fluid without risk of rapid degradation. One way to conduct passivation of silicon nanoparticles in a capture fluid is subject the nanoparticles and capture fluid to a temperature greater than 25° C., typically a temperature of 65° C. or close thereto, in air (preferably at 85% relative humidity) for a period of time, a period of time that typically is 12 to 72 hours, and that can be even longer than 72 hours. In some instances the period of time can be 168 hours or more. Longer periods of time can result in a greater extent of oxidation of the silicon nanoparticle surface particularly in a fluid that has a low oxygen and moisture permeability.

The capture fluid can contain additives dissolved or dispersed therein. Desirable additives can include surface modifiers that adhere to the surface of the nanoparticles as they are collected. Surface modifiers can render the nanoparticles more compatible with the capture fluid or some other medium with which the nanoparticles need to be combined, can render the surface of the nanoparticles reactive for further chemical reactions, or can both impart compatibility and reactivity. Examples of additives that can be included in the capture fluid include hydrocarbons (such as 1-alkenes) to aid in dispersing nanoparticles in hydrophobic media, oligoglycols (such as allyl ethers) to aid in dispersing nanoparticles in hydrophilic media, terminal olefins containing functional groups such as alcohols, carboxylates, amines and protected versions of these for post-passivation conversion and extraction, and fluorocarbons bearing terminal olefins to aid in dispersing nanoparticles in fluoropolymers.

It is possible to recycle or reuse a capture fluid in VHFLPP processes. That is, nanoparticles can be collected in the same capture fluid for multiple runs of the VHFLPP process. Typically, nanoparticles are isolated from the capture fluid prior to reusing the capture fluid, but that is not necessary. For example, nanoparticles can be collected in a capture fluid, passivated and then isolated from the capture fluid (for example, by filtration or centrifugation). The remaining capture fluid can then be used in a subsequent VHFLPP process.

The VHFLPP process can be run as a continuous or a pulsed process. A continuous VHFLPP process uses a constant and continuous radio frequency on the upstream ring electrode. In contrast, a pulsed VHFLPP process uses an amplitude modulated very high frequency (VHF) radio frequency signal applied to the upstream ring electrode. The amplitude modulated signal is typically operated from 1 to 50 Kilohertz as a square wave wavefunction that is multiplied to the continuous VHF sinusoidal waveform. Advantages to a pulsed process include using pulsed energy to control the size of the nanoparticles produced by controlling the residence time nanoparticle precursors are exposed to the high power plasma as they pass through the VHF glow discharge. In a continuous VHF plasma process (non-modulated), nanoparticle size can be controlled by the concentration of the nanoparticle precursor, silicon in the case of silicon nanoparticles and the residence time of the precursor through the VHF plasma.

The method of the present invention collects silicon nanoparticles in a capture fluid as they are made and is characterized by having a solid substrate submerged in the capture fluid during collection of silicon nanoparticles. A surprising discovery resulting in this invention is that solid substrates can reside in the capture fluid during the VHFLPP process resulting in nanoparticle deposition onto the surface of the solid substrate from the capture fluid. The capture fluid provides a medium in which freshly made silicon nanoparticles can disperse and then adhere to multiple surfaces of a solid substrate in the capture fluid.

The solid substrate is solid at 25 degrees Celsius (° C.). The solid substrate remains a solid when in the capture fluid. The solid substrate can be a single article such as a film, block, plate, ball, pellet, or object of any other shape. The solid substrate can alternatively be one of a multiple solid articles (substrates) in the capture fluid such as multiple pellets, granules, powder particles, or articles of any shape. That is, the capture fluid can contain multiple solid substrates at one time or a single solid substrate. When there are multiple solid articles (substrates) in the capture fluid the nanoparticles tend to deposit onto the surface of more than one, typically all of the solid articles (substrates) during the method of the present invention. The method of the present invention is particularly useful to disposing nanoparticles onto the surfaces of multiple solid articles at the same time.

In the broadest scope of the present invention, the solid substrate can be of any composition provided it is solid at 25° C. when in the capture fluid of the process. For example, the solid substrate can be or comprise glass, plastic, ceramic, metal, carbon, or salt. Glass refers to non-crystalline amorphous solid materials including volcanic glass and silicate glass, such as soda-lime glass, borosilicate glass, leaded glass, and aluminosilicate glass. Plastic refers to thermoplastic and/or thermoset polymer materials including polyethylene (including linear low density polyethylene and low density polyethylene), polypropylene, polystyrene, polyurethane, polyacrylics, polyesters, polycarbonates, and polyimides. Ceramic refers to materials such as boron nitride, alumina, aluminum nitride, ceria, silica, titania, and zirconia. Metals include iron, nickel, cobalt, copper, chromium, manganese and vanadium.

Any one or combination of more than one variation of the VHFLPP process described herein above can be used in the present method. For example, it is desirable to agitate the capture fluid and/or rotate the capture fluid reservoir during collection of the silicon nanoparticles. The capture fluid can be any of the capture fluids described above, including silicone oil or mineral oil. It can be desirable to include dispersed additives in the capture fluid. The additives can modify the surface of the silicon nanoparticles and/or the surface of the solid substrate. For example, the capture fluid can contain a compatiblizing agent that binds to the surface of the silicon nanoparticles when they enter the capture fluid and that enhance compatibility and/or reactivity of the silicon nanoparticles with the solid substrate. Desirably, the silicon nanoparticles are silicon quantum dots. The method can include passivation of the silicon nanoparticles. As described above, passivation desirably involves subjecting the nanoparticles in the capture fluid to a temperature greater than 25° C., typically a temperature of 65° C. or close thereto, in air (preferably at 85% relative humidity) for a period of time, a period of time that typically is 12 to 168 hours. An oxide coating forms over the nanoparticles in the capture fluid during the passivation step and the oxide layer protects the silicon nanoparticles from destructively rapid oxidation upon removal from the capture fluid and exposure to air. Passivation of the silicon nanoparticles occurs even while the silicon nanoparticles are on the surface of the solid substrate.

The method of the present invention can include isolation of the silicon nanoparticle coated solid substrate that forms in the capture fluid of the current method from the capture fluid. After passivation of the silicon nanoparticles, isolating the silicon nanoparticle coated solid substrate from the capture fluid can occur in air without special precautions. If the silicon nanoparticles are not passivated in the capture fluid, then isolation of the silicon nanoparticle coated solid substrate should occur in an inert atmosphere with a controlled amount of oxygen and moisture to avoid catastrophic oxidation of the silicon nanoparticles. The inert atmosphere can be free of moisture and oxygen or can contain just enough to allow slow oxidation of the silicon nanoparticle surface to passivate the silicon nanoparticles in a controlled manner. In the broadest scope of the present invention, isolation of the silicon nanoparticle coated solid substrate can occur by any means such as, for example, decantation, filtration, and/or physically picking out the silicon nanoparticle coated solid substrate from the capture fluid.

The method of the present invention provides a silicon nanoparticle coated solid substrate. The silicon nanoparticle coated solid substrate is a solid substrate with silicon nanoparticles adhered its surface. The method generally provides a coating over multiple surfaces (or a broader range of a substrate's surface) rather than just one side of the solid substrate that is directed towards a silicon nanoparticle-containing nanoparticle beam. As such, or additionally, the coating of silicon nanoparticles tends to be more uniform over the entire surface of a solid substrate than disposition methods apart from a capture fluid. Nanoparticles typically disperse within the capture fluid to some extent prior to coating the solid substrate, which allows not only coating of all sides of a solid substrate but also can facilitate penetration into cavities of the solid substrate to coat interior surfaces.

### EXAMPLES

For the following examples, use the following VHFLPP set up and procedure.

### VHFLPP Set Up

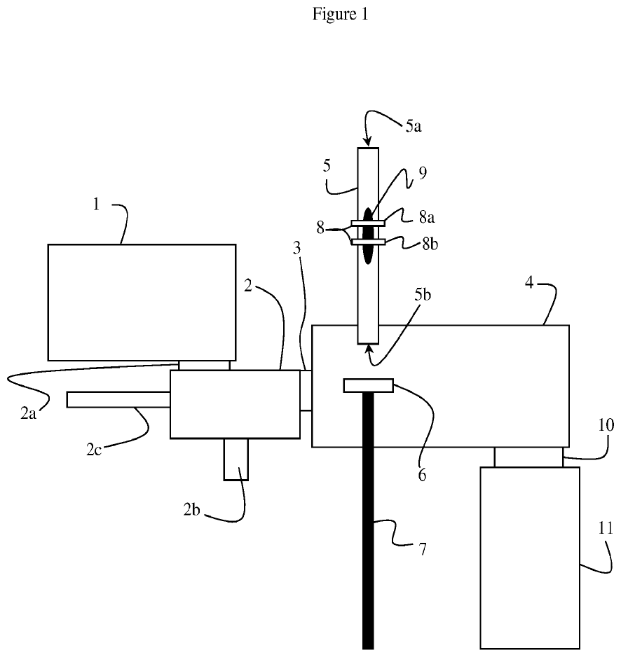

FIG. 1 illustrates a schematic of the VHFLPP set up for the present examples. Prepare samples in an inert environment such as a glove box, 1, that is purged with nitrogen gas. Connected to the glove box 1 is a vacuum load lock, 2. Samples can transfer from the inert gas purged glove box to the vacuum load lock upon opening a vacuum load lock seal, 2a, between the gas purged glove box and vacuum load lock. A roughing pump, 2b, is in fluid communication with the vacuum load lock. A rack and pinion arm, 2c, allows moving of items between the load lock 2 into a main capture chamber, 4. The vacuum load lock is separated from a main capture chamber, 4, by a gate valve 3. When gate valve 3 is open the vacuum load lock is in fluid communication with the main capture chamber. When gate valve 3 is closed then the vacuum load lock is isolated from the main capture chamber. The main capture chamber is connected to a high vacuum pump, 11, through gate valve 10. High vacuum pump 11 is a turbo-molecular pump (pump rate of 600 liters per second) that is backed by a roughing pump (Ebara S50 semiconductor pump with pump rate of 5,000 liters per minute). The main capture chamber is also in fluid communication with an upstream dielectric discharge tube, 5, through a dielectric discharge tube orifice, 5b. The dielectric discharge tube is a high purity fused quartz tube with a 7 millimeter inside diameter, 9.6 millimeter outside diameter and a length of 23 centimeters. Extending into the main capture chamber through a seal is capture fluid reservoir holder, 7, which holds capture fluid reservoir 6. The capture fluid reservoir holder can move towards or away from the dielectric discharge tube orifice in order to allow a user to position the capture fluid reservoir at a desired distance from the dielectric discharge tube orifice. During operation of the VHFLPP process, a gas stream comprising a precursor gas (or gasses) and an inert carrier gas (or gasses) flows into entrance end 5a of dielectric discharge tube 5, through the dielectric discharge tube and into the main collection chamber 4 through dielectric discharge tube orifice 5b. The diameter of the dielectric tube orifice is desirably adjustable in diameter and is adjusted to produce a pressure ratio of (discharge tube pressure)/(main capture chamber pressure) of 500 or more. The dielectric discharge tube has around it two electrodes, 8a and 8b, of dual ring copper electrode, 8.

### VHFLPP Process Operation

Produce silicon nanoparticles using the VHFLPP process and set up described herein above as follows. Within the glove box, place a capture fluid into the capture fluid reservoir and as indicated for a specific example, a solid substrate into the capture fluid. Transfer the capture fluid through the load lock barrier and into the load lock. Seal the load lock and evacuate the load lock using a roughing pump to a pressure of less than 2.67 Pa. Evacuate the main capture chamber using the high vacuum pump to a pressure of less than 6.67×10⁻⁵ Pa. Open gate valve 3 and transfer the capture fluid reservoir from the load lock and onto the capture fluid reservoir holder 7 in the main capture chamber using a rack and pinion transfer arm 2c. Close gate valve 3 and draw the pressure of the main capture chamber down to less than 6.67×10⁻⁵ Pa. Move the capture fluid reservoir holder to position the capture fluid reservoir a desired distance below the dielectric discharge tube orifice. Rotate the capture fluid reservoir holder (and, consequently, the capture fluid reservoir) at a rate of 12 revolutions per minute.

Feed a gas stream into end 5a of the dielectric discharge tube by metering in desired gases. Each example below identifies the composition of the desired gases making up the stream and their relative flow rates. Feed the gasses together into end 5a of the dielectric discharge tube to create the gas stream through the dielectric discharge tube.

Generate a very high frequency plasma 9 in the dielectric discharge tube between electrodes 8a and 8b while flowing the gas stream flowing through the dielectric discharge tube by applying a sine wave to the electrodes. Generate the sine wave with a Tektronix AFG 3252 function generator and an Electronic and Innovation 3200L Class A radio frequency amplifier connected to the electrodes. The sine wave across the electrodes produces a capacitively coupled very high frequency (frequency from 90-500 Megahertz) plasma within the dielectric discharge tube. Tune the frequency source to provide the maximum power coupled into the plasma while minimizing the drive amplitude of the sine wave. The coupled power density of the plasma is greater than 130 Watts per square centimeter (W/cm²).

Silicon nanoparticles form in the plasma and exit the dielectric discharge tube through orifice 5b and are collected in the capture fluid in the capture fluid reservoir.

Passivate the silicon nanoparticles by placing the silicon nanoparticle coated solid substrate, while in the capture fluid, at an aging temperature and aging humidity for an aging time as reported herein below.

Isolate the silicon nanoparticle coated solid substrate from the transfer fluid aver passivating. For coated pellets and powders, isolate the silicon nanoparticle coated substrate using a syringe filter (0.22 micrometer polytetrafluoroethylene filter available from CELLTREAT under product code 229778) with a 30 milliliter syringe. Load the silicon nanoparticle coated substrate and capture fluid into the syringe and depress the plunger to drive fluid through the syringe filter while retaining the silicon nanoparticle coated substrate. Rinse the silicone nanoparticle coated substrate with toluene to remove residual capture fluid and then dry at 25 to 110° C. for several hours optionally under a flow of inert gas. For larger objects such as glass sheets remove the silicon nanoparticle coated substrate from the capture fluid using tweezers or a spatula, rinse with toluene and dry at 25 to 110° C. for several hours optionally under a flow of inert gas.

### Silicon Nanoparticle Confirmation by Photoluminescence

Silicon nanoparticles luminesce when exposed to ultraviolet radiation only if they have a particle size in a range of 1 to 10 nanometers. Therefore, observation of luminescence is one means to confirm the silicon nanoparticles are silicon quantum dots.

In a dark room or space, expose a sample of a substrate that is coated with silicon nanoparticles with ultraviolet light using a handheld UVA LED flashlight (realUV 5 Watt LED flashlight from Waveform Lighting) to expose the silicon nanoparticles with 365 nanometer light. Hold the flashlight approximately 0.3 to 0.5 meters from the silicon nanoparticle coated substrate sample. Evaluate whether there is luminescence by visible observation of luminescence from the silicon nanoparticle coated substrate. Observation of luminescence confirms the presence of silicon quantum dots. Notably, all of the sample described below demonstrate bright luminescence thereby affirming the solid substrates are coated with silicon quantum dots.

### Samples

Prepare the following samples following the aforementioned procedure and the parameters in the tables below. Characterization of the samples are included in the tables below. Table 1 lists elements for making each of the samples.

TABLE 1

| Component | Description | Source |
|---|---|---|
| Nanoparticle | SiH₄/Ar | Air Liquide as SiH4-EG2 (99.999%)/Ar-EG3 |
| Precursor | (2% SiH₄ by mass in Ar) | (99.9999%) 2% by mass. |
| Ar Carrier Gas | Argon (99.9999%) | Air Liquide as Argon-EG3 (99.9999%) |
| H₂ Carrier Gas | Hydrogen (99.999%) | Air Liquide as Hydrogen-EG1 (99.999%) |
| Chlorine Dopant | Chlorine (99.99%) | Air Liquide as Chlorine-EG1 (99.99%) |
| Capture Fluid | Light mineral oil | Fisher Chemical as CAS: 8042-47-5 light |
| (light mineral oil) | | mineral oil |

Each of the Examples (Ex) use a solid substrate as identified below in the capture fluid. For Comparative Example (Comp Ex) A just use the solid substrate in the capture fluid reservoir without any capture fluid.

### Glass Solid Substrate

Example (Ex) 1—glass beads. Use a capture fluid consisting of 5.7 grams (g) of glass beads (silica beads, 30-40 course from Potters Industries) in 6 g of Capture Fluid (light mineral oil).

Ex 2—glass beads. Use a capture fluid consisting of 7.5 g of glass beads (silica beads, 30-40 course from Potters Industries) in 12 g of Capture Fluid (light mineral oil).

Ex 3—Glass Beads. Use a capture fluid consisting of 10 g of glass beads (silica beads, 30-40 course from Potters Industries) in 10 g of Capture Fluid (light mineral oil).

Ex 4-Hollow Glass Spheres. Use a capture fluid consisting of 0.61 g of hollow glass spheres (9-13 micrometer average size available as catalog number 440345 from Millipore Sigma) in 12 g of Capture Fluid (light mineral oil).

Ex 5-Glass Plates. Use a capture fluid consisting of 0.715 g of glass cover slips (borosilicate glass cover slips (Corning Glass coverslips No. 1, 22 millimeter square, catalog number 2865-22), from Corning) in 7.15 g of Capture Fluid (light mineral oil).

### Polymeric Solid Substrate

Ex 6—Low Density Polyethylene Powder. Use a capture fluid consisting of 1.63 g of low density polyethylene powder (polyethylene powder, low density, 500 micrometers, CAS no. 9002-88-4, from Alfa Acsar) in 12 g of Capture Fluid (light mineral oil).

### Ceramic Solid Substrate

Ex 7—Boron Nitride/Silicone Core/Shell Particles. Use a capture fluid consisting of 0.67 g of boron nitride/silicone core/shell particles in 11 g of Capture Fluid (light mineral oil). Prepare the boron nitride/silicone core/shell particles as follows: combine 16.8 weight-percent (wt %) 20 mm²/s (cSt) polydimethyl siloxane with h-BN spherical agglomerated particles (CTS7M from Saint-Gobain) in a Thinky ARE-310 planetary centrifugal mixer for four one-minute mixes at 2000 revolutions per minute to coat the BN particles with silicone. Place the silicone-coated BN particles into a glass vial having only one open end and with a NW25 vacuum port on the open end and internal glass baffles. Draw a vacuum on the glass vial to achieve an internal pressure of 0.7866 Pa and hold for 10 minutes. Meter in ultra-high purity argon gas (99.999%) into the glass vial at a rate of 50 standard cubic centimeters pr minute using a mass flow controller until the vial pressure reaches 35.46 Pa. rotate the glass vial at a rate of 15 revolutions per minute to tumble the BN particle inside of it. Apply a very high frequency (133 Megahertz) radio frequency signal to a copper coil surrounding the outside of the rotating glass vial to generate a capacitively coupled AR discharge inside the glass vial. Tune the very high frequency plasma power to 138 Watts and apply for 130 minutes, after which stop the plasma and argon gas flow and vent the glass vial to atmosphere. The particles inside now have BN cores with a silicone/SiOx surface coating. Remove the particle from the glass vial and rinse with deionized water and dry for 24 hours at 120° C. Diamond ATR-IR spectrometry confirms that the surface of the BN particles are coated with silicone. Visual observation of the particles reveal that the color went from bright white to straw yellow.

### Metal Solid Substrate

Ex 8—Iron Powder. Use a capture fluid consisting of 7.4 g of iron powder (iron particles/powder, −70 mesh (less than 212 micrometers) CAS No. 7439-89-6, from Acros Organics) in 10.4 g of Capture Fluid (light mineral oil).

Ex 9—Iron Powder. Use a capture fluid consisting of 3.4 g of iron powder (iron particles/powder, −70 mesh (less than 212 micrometers) CAS No. 7439-89-6, from Acros Organics) in 10 g of Capture Fluid (light mineral oil).

Ex 10—Nickel Powder. Use a capture fluid consisting of 1.4 g of nickel powder (iron particles/powder, −50+100 mesh CAS No. 7440-02-0, from Alfa Aesar) in 8.4 g of Capture Fluid (light mineral oil).

### Carbon Solid Substrate

Ex 11—Graphite Rods. Use a capture fluid consisting of 2.93 g of graphite rods (random mix of 2.0 millimeter diameter 2B Mr. Pen and 0.7 millimeter 2B NEOX rods (Length ranging from 0.2 to 4 centimeters. Available from Amazon.com) in 12 g of Capture Fluid (light mineral oil).

### Comparative Samples

Comparative Example A—Graphite Rods coated without a capture fluid. Repeat Ex 11 except do not include the 12 g of Capture Fluid. Instead, place the graphite rods into a capture reservoir on the capture fluid reservoir holder, but without a capture fluid present. Expose the graphite rods directly to a gas stream containing silicon nanoparticles during the process. After coating with silicon nanoparticles, remove the capture fluid reservoir from the deposition chamber through the load lock and place in a nitrogen-purged glove box. Add 12 g of mineral oil to the capture fluid reservoir to cover the coated graphite rods and remove the capture fluid reservoir from the glove box and expose to an atmosphere of 85% relative humidity at 60° C. for seven days.

Comparative Example B—hexagonal Boron Nitride Rods coated without a capture fluid. Place 2.69 g of hexagonal boron nitride (h-BN) rods (GE Advanced Ceramics Plug #: 130689 WO No. 143503, 3.175 mm diameter with various length 3-30 mm) into a capture reservoir on the capture fluid reservoir holder, but without a capture fluid present. Expose the h-BN rods directly to a gas stream containing silicon nanoparticles during the process. After coating with silicon nanoparticles, remove the capture fluid reservoir from the deposition chamber through the load lock and place in a nitrogen-purged glove box. Add 12 g of mineral oil to the capture fluid reservoir to cover the coated graphite rods and remove the capture fluid reservoir from the glove box and expose to an atmosphere of 85% relative humidity at 60° C. for seven days.

Comparative Example C—glass bead coated without a capture fluid. Place 5 g of glass beads (silica beads, 30-40 course from Potters Industries) into a capture reservoir on the capture fluid reservoir holder, but without a capture fluid present. Expose the glass beads directly to a gas stream containing silicon nanoparticles during the process. After coating with silicon nanoparticles, remove the capture fluid reservoir from the deposition chamber through the load lock and place in a nitrogen-purged glove box. Add 12 g of mineral oil to the capture fluid reservoir to cover the coated graphite rods and remove the capture fluid reservoir from the glove box and expose to an atmosphere of 85% relative humidity at 60° C. for seven days.

Comparative Example D—Low Density Polyethylene Powder coated without a capture fluid. Place 0.6 g of low density polyethylene powder (polyethylene powder, low density, 500 micrometers, CAS no. 9002-88-4, from Alfa Aesar) into a capture reservoir on the capture fluid reservoir holder, but without a capture fluid present. Expose the polyethylene powder directly to a gas stream containing silicon nanoparticles during the process. After coating with silicon nanoparticles, remove the capture fluid reservoir from the deposition chamber through the load lock and place in a nitrogen-purged glove box. Add 12 g of mineral oil to the capture fluid reservoir to cover the coated graphite rods and remove the capture fluid reservoir from the glove box and expose to an atmosphere of 85% relative humidity at 60° C. for seven days.

Comparative Example E—Low Density Polyethylene Beads coated without a capture fluid. Place 1 g of low density polyethylene beads (polyethylene beads, low density, 1-3 millimeters, CAS no. 9002-88-4, from Sigma-Aldrich) into a capture reservoir on the capture fluid reservoir holder, but without a capture fluid present. Expose the polyethylene beads directly to a gas stream containing silicon nanoparticles during the process. After coating with silicon nanoparticles, remove the capture fluid reservoir from the deposition chamber through the load lock and place in a nitrogen-purged glove box. Add 12 g of mineral oil to the capture fluid reservoir to cover the coated graphite rods and remove the capture fluid reservoir from the glove box and expose to an atmosphere of 85% relative humidity at 60° C. for seven days.

Table 2 presents the process parameters for the VHFLPP process for each of the Exs. The composition of the gas stream is generated by combining the listed gasses at the specified flow rate into the entrance end 5a of the dielectric discharge tube. Deposition time is the time the process runs generating silicon nanoparticles.

Table 3 presents the power and passivation parameters for the VHFLPP process. Drive amplitude is reported in terms of milliVolts peak-to-peak (mVpp).

Each of the samples luminesce upon exposure to ultraviolet light thereby confirming they are solid substrates coated with silicon quantum dots. None of the samples requires an adhesion promoter to adhere the silicon quantum dots to the solid substrate. Moreover, each of the Exs luminesce uniformly evidencing an even coating of silicon quantum dots.

Notably, Comparative Example A luminesces but unevenly over the graphite rods, indicative of an uneven coating. In contrast, Ex 10 luminesces evenly over the graphite rode, indicative of an even coating. Comp Ex A and Ex 10 illustrate that coating in a capture fluid achieves a more uniform coating of silicon nanoparticles. Comparative Examples B-E, which were coated with silicon quantum dots apart from capture fluid, also demonstrate uneven luminesce evident of an uneven coating of quantum dots. A comparison of the Exs and Comp Exs reveals that coating solid substrates while submerged in a capture fluid results in a more even coating of the solid substrate with quantum dots than coating a solid substrate apart from a capture fluid.

These Examples illustrate successful coating of a variety of solid substrates with silicon nanoparticles, silicon quantum dots in particular, by a direct coating method where the solid substrate is in a capture fluid and the silicon nanoparticles are directed into the capture fluid directly upon generation without requiring an adhesion promoter. The examples also illustrate successful passivation of the silicon quantum dots on the surface of the solid substrate without having to remove them from the capture fluid or maintain them in an inert atmosphere while in the capture fluid.

TABLE 2

| | Gas Flow Rate (cubic | | | | | | Capture | |
|---|---|---|---|---|---|---|---|---|
| | centimeter per minute) | | | | | | Fluid | |
| | | Nanoparticle | | | Pressure (Pa) | | Distance | |
| | | Precursor | | | Dielectric | Main | from | Deposition |
| | | (SiH₄/Ar | | | Discharge | Capture | Orifice | Time |
| Sample | Ar | blend) | H₂ | Cl₂ | Tube | Chamber | (cm) | (minutes) |
| Ex 1 | 25 | 60 | 3 | 0.3 | 336 | 0.16 | 6.5 | 80 |
| Ex 2 | 30 | 60 | 3 | 0.5 | 389 | 0.16 | 5 | 140 |
| Ex 3 | 25 | 60 | 5 | 0.3 | 379 | 0.17 | 6.5 | 105 |
| Ex 4 | 47 | 40 | 3 | 0.5 | 435 | 0.17 | 6.5 | 110 |
| Ex 5 | 40 | 50 | 3 | 0.5 | 507 | 0.17 | 5 | 60 |
| Ex 6 | 47 | 40 | 5 | 0 | 420 | 0.19 | 6.5 | 62 |
| Ex 7 | 50 | 35 | 3 | 0.3 | 385 | 0.17 | 6.5 | 75 |
| Ex 8 | 50 | 35 | 3 | 0.3 | 365 | 0.17 | 6.5 | 67 |
| Ex 9 | 50 | 35 | 5 | 0 | 376 | 0.19 | 6.5 | 65 |
| Ex 10 | 50 | 35 | 3 | 0.3 | 369 | 0.17 | 6.5 | 70 |
| Ex 11 | 30 | 60 | 5 | 0 | 356 | 0.19 | 3 | 47 |
| Comp Ex A | 30 | 60 | 5 | 0 | 347 | 0.19 | 3 | 20 |
| Comp Ex B | 50 | 40 | 5 | 0 | 397 | 0.19 | 6.5 | 42 |
| Comp Ex C | 45 | 40 | 3 | 0.5 | 381 | 0.15 | 9.5 | 90 |
| Comp Ex D | 50 | 35 | 3 | 0.3 | 456 | 0.17 | 6.5 | 45 |
| Comp Ex E | 50 | 35 | 3 | 0.3 | 460 | 0.17 | 6.5 | 45 |

TABLE 3

| | | | | | | | Power | Passivation | | |
|---|---|---|---|---|---|---|---|---|---|---|
| | | Drive | | | | Power | Coupling | | Aging | Aging |
| | Frequency | Amplitude | Power | | | Density | Efficiency | Aging Temp | Humidity | Time |
| Ex | (MHz) | (mVpp) | Forward | Reflected | Coupled | (W/cm²) | (%) | (° C.) | (% R.H.) | (days) |
| Ex 1 | 129 | 305 | 185 | 61 | 124 | 173.91 | 67.03 | 60 | 85 | 14 |
| Ex 2 | 129 | 300 | 180 | 62 | 118 | 165.50 | 65.56 | 65 | 85 | 14 |
| Ex 3 | 129 | 314 | 199 | 66 | 133 | 186.54 | 66.83 | 60 | 85 | 14 |
| Ex 4 | 129 | 300 | 181 | 61 | 120 | 168.30 | 66.30 | 60 | 85 | 7 |
| Ex 5 | 129 | 300 | 172 | 60 | 112 | 157.08 | 65.12 | 60 | 85 | 7 |
| Ex 6 | 129 | 310 | 190 | 64 | 126 | 176.72 | 66.32 | 60 | 85 | 7 |
| Ex 7 | 129 | 330 | 195 | 65 | 130 | 182.33 | 66.67 | 60 | 85 | 7 |
| Ex 8 | 129 | 325 | 192 | 65 | 127 | 178.12 | 66.15 | 60 | 85 | 7 |
| Ex 9 | 129 | 305 | 181 | 60 | 121 | 169.71 | 66.85 | 60 | 85 | 7 |
| Ex 10 | 129 | 320 | 188 | 62 | 126 | 176.7 | 67.02 | 60 | 85 | 7 |
| Comp Ex A | 129 | 300 | 173 | 57 | 116 | 162.7 | 67.05 | 60 | 85 | 7 |
| Comp Ex B | 129 | 310 | 177 | 61 | 116 | 162.69 | 65.54 | 60 | 85 | 7 |
| Comp Ex C | 129 | 315 | 196 | 67 | 129 | 180.93 | 65.82 | 60 | 85 | 7 |
| Comp Ex D | 129 | 310 | 189 | 64 | 125 | 175.32 | 66.14 | 60 | 85 | 7 |
| Comp Ex E | 129 | 310 | 195 | 67 | 128 | 179.52 | 65.64 | 60 | 85 | 7 |

1. An article comprising:
a. a windowpane having opposing primary surfaces and edges extending around the primary surfaces;
b. a window frame that resides around at least a portion of the edges of the windowpane; and
c. a sealant in light-transmitting contact with an edge of the windowpane;
wherein the sealant comprises quantum dots.

2. The article of claim 1, wherein the article comprises multiple windowpanes each having opposition primary surfaces and edges extending around the primary surfaces and wherein the window frame resides around at least a portion of the edges of both windowpanes and the sealant is between one or both windowpanes and the window frame.

3. The article of claim 1, wherein the article further comprises a solar cell in light-transmitting contact with the sealant and/or at least one edge of at least one windowpane.

4. The article of claim 1, wherein the article comprises reflective material in light-transmitting contact with a portion of one or more edges of a windowpane.

5. The article of claim 1, wherein quantum dots are: (i) dispersed in at least one windowpane; and/or (ii) dispersed on and/or in a film or coating on a primary surface of a windowpane.

6. The article of claim 1, wherein the quantum dots are silicon quantum dots.

7. The article of claim 1, wherein the sealant is a silicone sealant with silicon quantum dots dispersed therein.

8. The article of claim 1, wherein the article comprises a laminated glass windowpane that has glass sheets laminated together with a polymeric film between the glass sheets, and that optionally comprises quantum dots in the polymeric film.

9. The article of claim 1, wherein the article comprises two or more windowpanes separated from one another to define a volume between them that is sealed and that has in the volume between them a vacuum or insulating gas, wherein the article optionally further comprises quantum dots in one or more of the windowpanes and/or on a surface of one or more of the windowpanes.
